(19) United States
(12) Patent Application Publication
(10) Pub. No.: US 2016/0134445 A1
(43) Pub. Date: May 12, 2016

(54) WIRING SUBSTRATE

(71) Applicant: Samsung Electro-Mechanics Co., Ltd., Suwon-si (KR)

(72) Inventor: Hong In KIM, Suwon-si (KR)

(73) Assignee: SAMSUNG ELECTRO-MECHANICS CO., LTD., Suwon-si (KR)

(21) Appl. No.: 14/841,361

(22) Filed: Aug. 31, 2015

(30) Foreign Application Priority Data
Nov. 10, 2014 (KR) 10-2014-0155278

(51) Int. Cl. H05K 1/02

(52) U.S. Cl. CPC H04L 25/085; H04L 25/0274

(57) ABSTRACT

A wiring substrate may include an insulating layer, a differential signal transmission line configured to include a first wire and a second wire disposed inside the insulating layer to be spaced apart from each other in a thickness direction of the substrate, the first wire and the second wire transmitting differential signals, and a first ground layer disposed between the first wire and the second wire.

### CROSS-REFERENCE TO RELATED APPLICATION

This application claims the priority and benefit of Korean Patent Application No. 10-2014-0155278 filed on Nov. 10, 2014, with the Korean Intellectual Property Office, the disclosure of which is incorporated herein by reference.

### BACKGROUND

The present disclosure relates to a wiring substrate.

In general, a plurality of components may be mounted on a printed circuit board, and a wiring for transmitting signals between the components may be formed on the printed circuit board. Recently, in accordance with rapid technology development in the related art, data signals are being transmitted through the wirings at high speeds, and the mounted components have been further developed to respond at high speeds.

An electric field induced in a direction of current flow is formed around individual wires of a wiring by which data is transmitted, and the electric field emission may cause an electromagnetic interference (EMI) phenomenon, which interrupts normal component operations by carrying noise in a signal transmitted to adjacent wires.

According to the related art, an electric field emission has been significantly reduced through the use of a pair of wires transmitting differential signals having the same amplitude and opposite phases in order to solve the above-mentioned problem. Specifically, according to the related art, the electric field emission has been significantly reduced by disposing differential signal lines in parallel to each other, so that magnetic fields generated by respective wires in different directions are offset by each other.

However, in a case of the printed circuit board which features differential signal transmission lines, according to the related art described above, since the pair of wires are spaced apart from each other by a predetermined distance in a parallel manner and may be disposed to be spaced apart from adjacent differential signal transmission lines by a predetermined distance, while grounds are disposed between the differential signal transmission lines in order to significantly reduce signal distortion due to interference between the differential signal transmission lines, a significantly large area may be required to form wirings transmitting differential signals. Thus, miniaturization of the printed circuit board may be difficult.

### SUMMARY

An exemplary embodiment in the present disclosure may provide a wiring substrate capable of decreasing a distance between first and second wires transmitting differential signals by disposing the first and second wires to face each other in relation to a first ground layer and easily adjusting impedance of a differential signal transmission line by disposing second and third ground layers to be spaced apart from the first ground layer by a predetermined distance.

According to exemplary embodiment in the present disclosure, a wiring substrate may include: an insulating layer; a differential signal transmission line including a first wire and a second wire disposed inside the insulating layer to be spaced apart from each other in a thickness direction of the substrate, the first wire and the second wire transmitting differential signals; and a first ground layer disposed between the first wire and the second wire.

According to an exemplary embodiment in the present disclosure, a wiring substrate may include: an insulating layer; a differential signal transmission line including a first wire and a second wire disposed inside the insulating layer to be spaced apart from each other in a thickness direction of the substrate, the first wire and the second wire transmitting differential signals; and a first ground layer disposed between the first wire and the second wire and having the same width as a width of each of the first wire and the second wire, wherein the first wire and the second wire are disposed to be vertically symmetrical to each other in relation to the first ground layer.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a view illustrating a wiring substrate according to an exemplary embodiment in the present disclosure;

FIG. 2 is a view illustrating a wiring substrate according to another exemplary embodiment;

FIG. 3 is a view illustrating a width of each wire and a distance between wires in a differential signal transmission line, a distance between first and second ground layers and a distance between first and third ground layers for impedance matching;

FIG. 4 is a view illustrating a wiring substrate according to another exemplary embodiment; and

FIG. 5 is a view illustrating a wiring substrate according to another exemplary embodiment.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

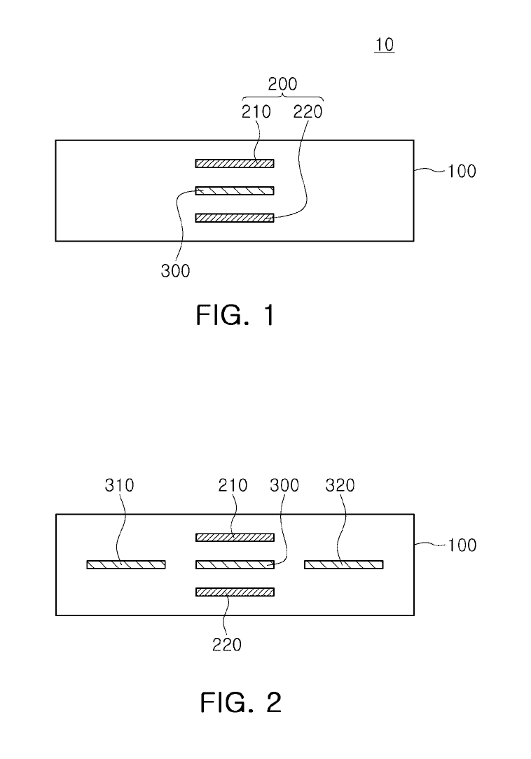

FIG. 1 is a view illustrating a wiring substrate according to an exemplary embodiment.

Referring to FIG. 1, a wiring substrate 10, according to an exemplary embodiment, may include an insulating layer 100, a differential signal transmission line 200, and a first ground layer 300.

The insulating layer 100 may include a first wire 210 and a second wire 220 disposed to be spaced apart from each other by a predetermined distance in a thickness direction of the substrate, and the first ground layer 300 disposed between the first wire 210 and the second wire 220.

A thickness of the insulating layer 100 may be changed in accordance with a channel capacity design of the differential signal transmission line 200 and may include ceramic powder having a high dielectric constant, such as barium titanate (BaTiO₃) based powder or strontium titanate (SrTiO₃) based powder. However, the present inventive concept is not limited thereto.

In addition, various ceramic additives, an organic solvent, a plasticizer, a binder, a dispersing agent, and the like may be added to the ceramic powder in accordance with the objective of the present inventive concept.

An average particle diameter of the ceramic powder used for forming the insulating layer 100 is not particularly limited, but may be adjusted in order to achieve the objective of the present inventive concept. For example, the average particle diameter may be adjusted to 400 nm or less.

The differential signal transmission line 200 may include the first wire 210 and the second wire 220 that transmit differential signals, and the first wire 210 and the second wire 220 maybe disposed inside the insulating layer 100 to be spaced apart from each other by a predetermined distance in the thickness direction of the substrate.

The first ground layer 300 may be disposed between the first wire 210 and the second wire 220. According to an exemplary embodiment, a width w of each of the first wire 210 and the second wire 220 may be the same as a width w of the first ground layer 300. In addition, according to an exemplary embodiment, the first wire 210 and the second wire 220 may be disposed to be vertically symmetrical to each other in relation to the first ground layer 300.

Here, differential signals refer to signals having the same amplitude and opposite phases, and the differential signal transmission line 200 transmits a positive polarity signal through the first wire 210 and simultaneously transmits a negative polarity signal through the second wire 220, such that electric fields generated by the respective wires maybe offset by an interaction therebetween.

Specifically, when the positive polarity signal is converted from a low level to a high level, the negative polarity signal may be converted from a high level to a low level. In this case, directions of currents flowing in both wires are opposite each other and the electric fields are formed in directions opposite to the directions of the currents according to Fleming's rule, whereby the electric fields may be offset.

The first ground layer 300 may be disposed between the first wire 210 and the second wire 220. According to an exemplary embodiment, the first ground layer 300 may have the same width as the widths w of the first wire 210 and the second wire 220.

Here, the first ground layer 300 may provide a common reference level for the differential signals transmitted through the first wire 210 and the second wire 220. In a case in which the first wire 210 and the second wire 220 form paths connected to different ground layers, noise or distortion may occur in the signals transmitted through the differential signal transmission line 200 due to different reference levels provided from the different ground layers.

That is, the first ground layer 300 may be disposed between the first wire 210 and the second wire 220 to provide a common reference level, thereby preventing a noise occurrence or a signal distortion due to the noise occurrence.

FIG. 2 is a view illustrating a wiring substrate according to another exemplary embodiment.

Referring to FIG. 2, the wiring substrate 10, according to another exemplary embodiment, may include the insulating layer 100, the differential signal transmission line 200, the first ground layer 300, a second ground layer 310, and a third ground layer 320.

A basic configuration of the wiring substrate 10 in the exemplary embodiment of FIG. 2 is the same as that in the exemplary embodiment of FIG. 1; however, there is a difference in that the wiring substrate 10 in the exemplary embodiment of FIG. 2 further includes the second ground layer 310 and the third ground layer 320 disposed to be spaced apart from the first ground layer 300 by a predetermined distance.

According to an exemplary embodiment, the first ground layer 300, and the second ground layer 310 and the third ground layer 320 may be disposed to be spaced apart from each other by a first distance s. Here, the differential signals transmitted through the first wire 210 and the second wire 220 maybe coupled to each other in a space between the first ground layer 300 and the second ground layer 310 and a space between the first ground layer 300 and the third ground layer 320.

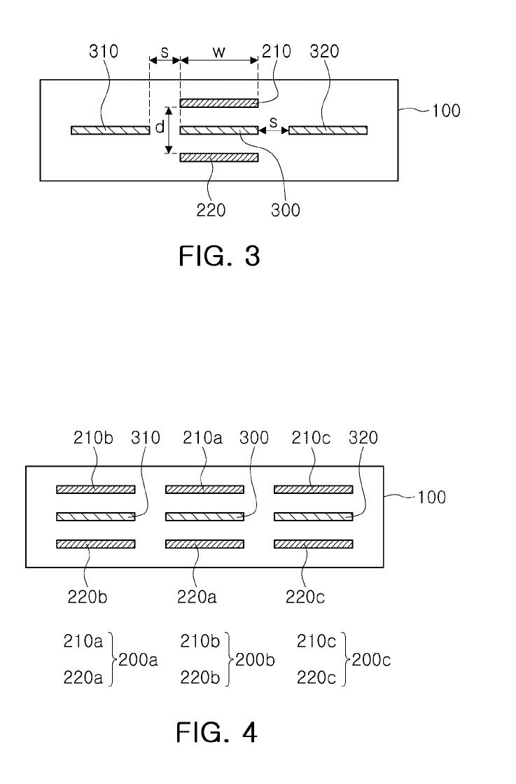

Therefore, as the first distance s is increased, parasitic capacitance between the first wire 210 and the second wire 220 may be increased. As a result, impedance of the differential signal transmission line 200 may be decreased. That is, the impedance of the differential signal transmission line 200 may be adjusted by adjusting the first distance s. Impedance matching of the differential signal transmission line 200 using the configuration described above will be described in more detail with reference to FIG. 3.

FIG. 3 is a view illustrating a width of each wire and a distance between wires in a differential signal transmission line, a distance between first and second ground layers and a distance between first and third ground layers for impedance matching.

Referring to FIG. 3, the first wire 210 and the second wire 220 may be disposed to be spaced apart from each other by a distance d in a thickness direction of the substrate. In addition, the first wire 210, the second wire 220, and the first ground layer 300 may be formed to have a predetermined width w. In addition, the first ground layer 300 and the second ground layer 310 may be disposed to be spaced apart from each other by a distance s, and the first ground layer 300 and the third ground layer 320 may be disposed to be spaced apart from each other by a distance s.

According to an exemplary embodiment, the wiring substrate 10 may be formed by adjusting the distance d between the first wire 210 and the second wire 220, the width w of each of the first wire 210, the second wire 220 and the first ground layer 300, or the distance s between the first ground layer 300 and the second ground layer and the distance s between the first ground layer 300 and the third ground layer 320, so that the differential signal transmission line 200 may have target impedance for impedance matching.

An impedance value of the differential signal transmission line 200 may be associated with a change in a capacitance value by the coupling of the first wire 210 and the second wire 220. As the capacitance value is increased, the impedance value may be decreased. Conversely, as the capacitance value is decreased, the impedance value may be increased.

According to an exemplary embodiment, the distance s between the first ground layer 300 and the second and third ground layers 310 and 320 may be determined depending on the target impedance of the differential signal transmission line 200, as well as the distance d between the first and second wires 210 and 220.

Specifically, as the distance d between the first wire 210 and the second wire 220 is decreased, the degree of coupling between the differential signals transmitted through the first and second wires 210 and 220 may be increased, so that the capacitance value may also be increased. As a result, the impedance value may be decreased.

In addition, as the distance s between the first ground layer 300 and the second ground layer 310 or the distance s between the first ground layer 300 and the third ground layer 320 is increased, the degree of coupling between the differential signals transmitted through the first and second wires 210 and 220 maybe increased, so that the capacitance value may also be increased. As a result, the impedance value may be decreased.

The impedance of the differential signal transmission line 200 may be matched by adjusting the distance d between the first wire 210 and the second wire 220, the distance s between the first ground layer 300 and the second ground layer 310, or the distance s between the first ground layer 300 and the third ground layer 320, using the above-mentioned relationship.

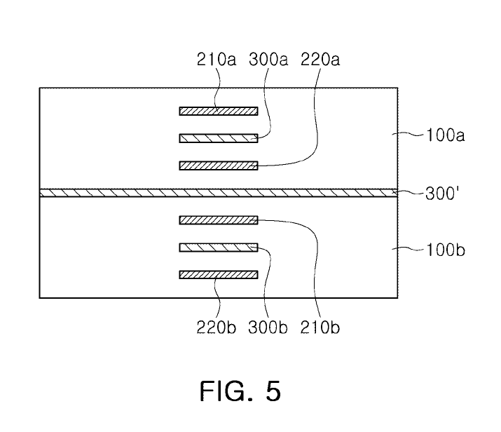

FIG. 4 is a view illustrating a wiring substrate according to another exemplary embodiment, and FIG. 5 is a view illustrating a wiring substrate according to another exemplary embodiment.

The wiring substrate, according to another exemplary embodiment, maybe expanded in a horizontal direction, as shown in FIG. 4. In addition, the wiring substrate, according to another exemplary embodiment, may be expanded in a vertical direction, that is, a thickness direction of the substrate, as shown in FIG. 5.

Referring to FIG. 4, one insulating layer 100 may include a plurality of differential signal transmission lines 200a, 200b, and 200c that transmit different signals. Here, in the plurality of differential signal transmission lines 200a, 200b, and 200c, first wires 210a, 210b, and 210c and second wires 220a, 220b, and 220c may be disposed to be symmetrical to each other in relation to the ground layers 300, 310, and 320.

Here, the plurality of differential signal transmission lines 200a, 200b, and 200c may be disposed to be spaced apart from each other by a distance sufficient to prevent the occurrence of signal interference.

Referring to FIG. 5, a wiring substrate may include first wires 210a and 210b and second wires 220a and 220b disposed in different insulating layers 100a and 100b, respectively, wherein the first wires 210a and 210b and the second wires 220a and 220b may be symmetrical to each other in relation to insulating layers 300a and 300b.

In this case, a ground layer 300′ may be formed between the fire wire 210b in the lower insulating layer 100b and the second wire 220a in the upper insulating layer 100a, thereby preventing the occurrence of signal interference therebetween.

As set forth above, according to exemplary embodiments, a distance between first and second wires transmitting differential signals may be reduced by disposing the first and second wires to face each other in relation to a first ground layer, and the impedance of a differential signal transmission line may be easily adjusted by disposing second and third ground layers to be spaced apart from the first ground layer by a predetermined distance.

While exemplary embodiments have been shown and described above, it will be apparent to those skilled in the art that modifications and variations could be made without departing from the scope of the present invention as defined by the appended claims.

What is claimed is:

1. A wiring substrate comprising:
an insulating layer;
a differential signal transmission line configured to include a first wire and a second wire disposed inside the insulating layer to be spaced apart from each other in a thickness direction of the substrate, the first wire and the second wire transmitting differential signals; and
a first ground layer disposed between the first wire and the second wire.

2. The wiring substrate of claim 1, wherein the first wire and the second wire are disposed to be vertically symmetrical to each other in relation to the first ground layer.

3. The wiring substrate of claim 1, wherein a width of the first ground layer is the same as a width of each of the first and second wires.

4. The wiring substrate of claim 1, further comprising a second ground layer and a third ground layer disposed to be spaced apart from both sides of the first ground layer by a predetermined distance.

5. The wiring substrate of claim 4, wherein the second ground layer and the third ground layer are disposed to be spaced apart from the first ground layer by a first distance, and
the first distance is determined depending on target impedance of the differential signal transmission line and a distance between the first wire and the second wire.

6. The wiring substrate of claim 5, wherein when the distance between the first wire and the second wire is the same as a width of each of the first and second wires, the first distance is decreased as the target impedance is increased.

7. A wiring substrate comprising:
an insulating layer;
a differential signal transmission line configured to include a first wire and a second wire disposed inside the insulating layer to be spaced apart from each other in a thickness direction of the substrate, the first wire and the second wire transmitting differential signals; and
a first ground layer disposed between the first wire and the second wire and having the same width as a width of each of the first and second wires,
wherein the first wire and the second wire are disposed to be vertically symmetrical to each other in relation to the first ground layer.

8. The wiring substrate of claim 7, further comprising a second ground layer and a third ground layer disposed to be spaced apart from both sides of the first ground layer by a predetermined distance.

9. The wiring substrate of claim 8, wherein the second ground layer and the third ground layer are disposed to be spaced apart from the first ground layer by a first distance, and the first distance is determined depending on target impedance of the differential signal transmission line and a distance between the first wire and the second wire.

10. The wiring substrate of claim 9, wherein when the distance between the first wire and the second wire is the same as a width of each of the first and second wires, the first distance is decreased as the target impedance is increased.
